(19) United States
(12) Patent Application Publication
(10) Pub. No.: US 2022/0151316 A1
(43) Pub. Date: May 19, 2022

(54) FRAME FOR A MEDICAL FACE MASK

(71) Applicants: James E. Grove, Marina Del Rey, CA (US); Michael S. Weinstock, Malibu, CA (US)

(72) Inventors: James E. Grove, Marina Del Rey, CA (US); Michael S. Weinstock, Malibu, CA (US)

(21) Appl. No.: 17/097,999

(22) Filed: Nov. 13, 2020

(51) Int. Cl. A41D 13/11; A62B 18/02

(52) U.S. Cl. CPC A41D 13/1161; A62B 18/025

(57) ABSTRACT

A slide-on, slide-off frame is disclosed that carries a medical face mask of the kind to be worn by healthcare providers and others who wish to avoid contracting or spreading an infectious disease, such as the coronavirus known as COVID-19. The frame includes a bridge to which the face mask is attached. A pair of L-shaped ear engaging arms stand upwardly from opposite ends of the bridge to lie on top of the wearer's ears to hold the frame on the wearer's face. In one embodiment, the upstanding ear engaging arms are rotatable downwardly into the plane of the bridge so that the frame can be carried in a purse or hand bag. In another embodiment, the frame is manufactured from a single continuous piece of material, such that the face mask is slidable off the bridge and removed from the frame.

### BACKGROUND OF THE INVENTION

### Field of the Invention

This invention relates to a comfortable to wear and lightweight slide-on, slide-off frame that carries a medical face mask of the kind to be worn by healthcare providers and others who wish to avoid contracting or spreading an infectious disease, such as the coronavirus known as COVID-19. By virtue of the manner in which the frame is configured, the mask carried by the frame is advantageously held snug against the face of a wearer without requiring that the wearer surround his or her ears with elastic or string ties or loops such that the mask will not slide down the face of the wearer during use.

### Background Art

Medical face masks are commonly worn by healthcare providers and others in an environment in which the wearer may encounter or could spread a contagious disease. By way of example, with the coronavirus referred to as COVID-19 affecting individuals around the world, it has become increasingly important for the populace to have ready access to a supply of face masks for the purpose of preventing infected individuals from spreading the disease to others and to better the chance that healthy individuals will not become infected should they enter a space that is or has been occupied by an infected individual.

Most face masks that are used for this purpose have ties or loops which surround a wearer's ears in order for the masks to be held against the wearer's face. By way of example, FIGS. 1 and 2 of the drawings show a pair of conventional Thee masks 100 and 200 having loops 150 and 250 surrounding a wearer's ears to hold the mask up, However, such wrap around ties and loops do not always hold the mask snug against the face of the wearer, In this case, the mask is known to slide down the wearer's face and expose his or her nose. Consequently, the mask requires frequent and often annoying adjustments on the wearer's face. In the case where the mask is attached to the wearer's face by pairs of ties located at each side, the ties must be tied together with sufficient tightness to hold the mask in place. Should it be found that the mask is loose, the tying step must be repeated. The usual wrap around ties and loops can also become entangled with a wearer's hair or ear jewelry. What is even more, ties and loops that wrap around a wearer's ears are known to apply pressure against, the back of the ears which can become uncomfortable after the mask has been worn for a long time. Likewise, these masks are not adapted to be simply and quickly pushed onto and pulled off the wearer's face.

To avoid the shortcomings listed above that are characteristic of a conventional medical face mask, it would be desirable to have access to a compact, lightweight frame to which a face mask is attached, where the frame can be easily and quickly attached to and removed from the face of a user, that can reliably hold the mask snug against the face of a wearer to avoid the necessity of having to make frequent adjustments, and that can hold the mask up on the wearer's face without requiring ties, loops or the like that surround and apply uncomfortable pressure to the back of the wearer's ears.

### SUMMARY OF THE INVENTION

In general terms, a lightweight and comfortable to wear frame is disclosed by which to carry a medical face mask of the kind that is typically worn by healthcare providers and other individuals who wish to avoid contracting or spreading an infectious disease, such as, for example, a coronavirus, namely that known as COVID-19. The frame eludes a curved bridge to which the face mask is attached. The bridge is preferably a thin flexible rod that is manufactured from molded plastic or metal and shaped to conform to the face of a wearer. An outward projection is formed at the front and center of the bridge to accommodate the nose of the wearer. The frame includes L-shaped ear engaging arms that, according to a first embodiment, are hingedly connected at first ends thereof to respective opposite ends of the bridge, The ear engaging arms are rotatable relative to the bridge between a ready to wear configuration of the frame at which the ear engaging arms stand vertically upward from the opposite ends of the bridge and a compact folded configuration of the frame at which the ear engaging arms are rotated downwardly so as to lie flat and in the same plane as the bridge. In its compact folded configuration, the flame is sized to be conveniently carried in a handbag or a purse of the wearer.

The opposite ends of the L-shaped ear engaging arms bend rearwardly to create ear rests. When the frame is placed against the face of the wearer in its ready to wear configuration, the ear rests lay entirely above and on top of the wearer's ears. That is, the ear rests do not surround or wrap around the ears of the wearer to advantageously avoid applying pressure to the back of the wearer's ears or catching onto the wearer's hair or ear jewelry. The frame is uniquely configured to bold the mask that is attached to the bridge snug against the face of the wearer. In particular, the bridge of the frame slopes continuously downward from the nose projection at the front and center of the bridge to an engagement point at each of the opposite ends of the bridge to which the first ends of the ear engaging arms of the frame are hingedly connected. So that the frame will reliably hold the mask up and close to the user's face, the engagement points on the frame at the intersection of the ear engaging arms and the opposite ends of the bridge are configured to lie alongside the wearer's ear lobes and above the wearer's temporal mandibular joints at opposite sides of the wearer's head.

In an alternative embodiment, the frame is manufactured from a single continuous piece (e.g., a rod) of flexible material. In this case, the one-piece frame remains at all times in a ready to wear configuration. L-shaped ear engaging arms are coextensively joined to and stand vertically upward from opposite ends of the frame. Ear rests extend rearwardly from the tops of the ear engaging arms to lay entirely above and rest on top of the wearer's ears. The one-piece frame includes a curved bridge that runs through a looped hem that is formed along the top of a medical face mask by which the mask is attached to and suspended from the bridge, The mask is slidable along and off the bridge to be removed from the frame. The mask may then be cleaned and reused or replaced by a new mask to be returned into sliding engagement with the bridge.

### BRIEF DESCRIPTION OE THE DRAWINGS

FIGS. 1 and 2 show examples of conventional face masks being held against the face of an individual by loops which surround the individual's ears:,

FIG. 3 shows an individual wearing on his face a frame according to a first embodiment of this invention to which a medical face mask is attached;

FIG. 4 is a cross-section taken along lines 4-4 of FIG. 3;

FIG. 5 is a perspective view of the frame shown in FIG. 3 in a ready to wear configuration;

FIG. 6 is a top plan view of the frame shown in FIG. 5;

FIG. 7 shows the frame configured in a manner so that the face mask that is attached thereto is held snug against the face of the wearer;

FIG. 8 shows an individual wearing on his face a frame according to an alternate embodiment of this invention to which a medical face mask is removably attached;

FIG. 9 is a perspective view of the frame shown in FIG. 8; and

FIG. 10 is a top plan view of the flame shown in FIG. 9.

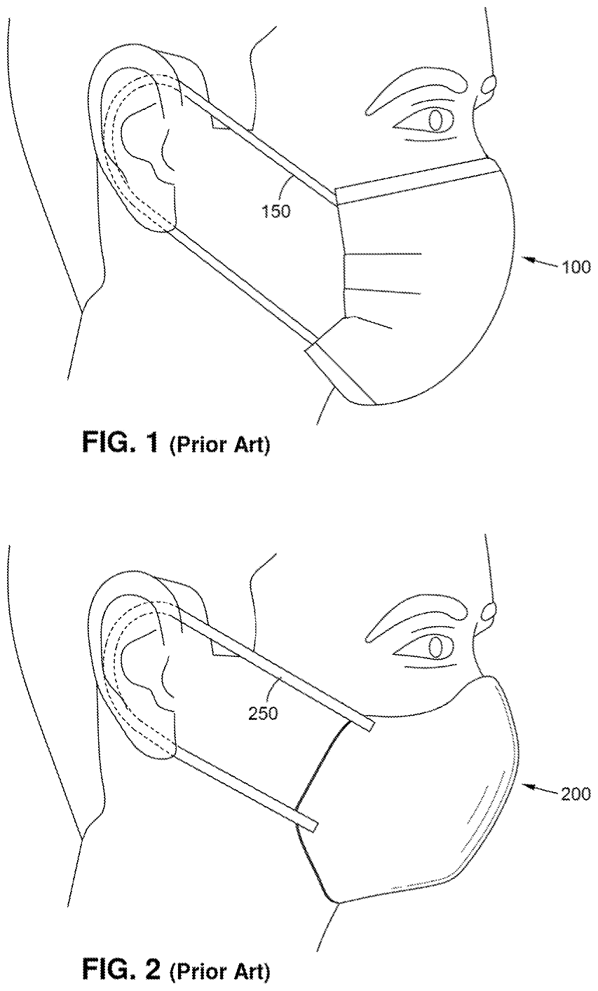

### DESCRIPTION OF THE PREFERRED EMBODIMENT

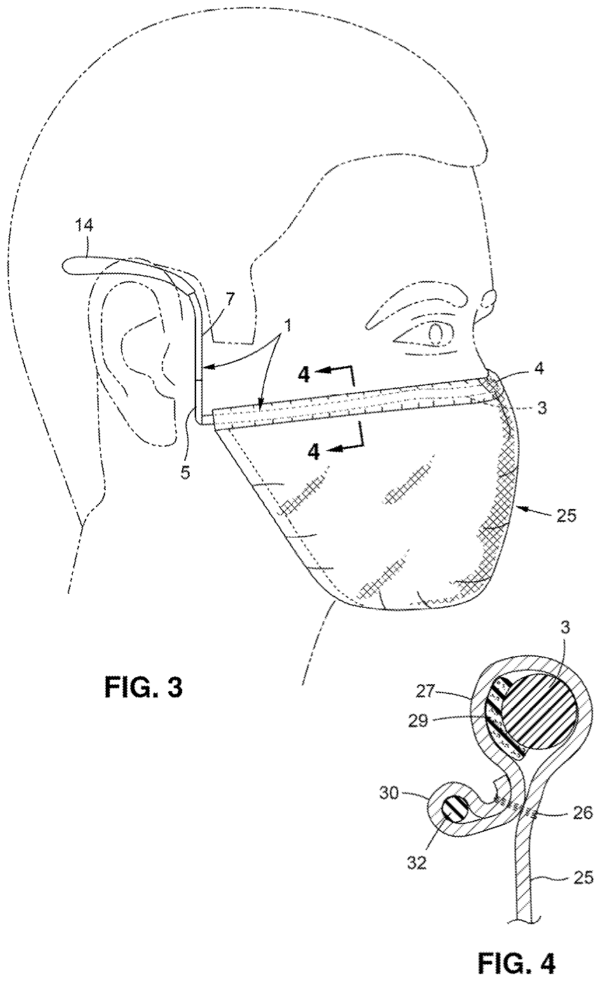

A first embodiment for a lightweight, comfortable to wear frame 1 for a medical face mask 25 is described while referring concurrently to FIGS. 3-7 of the drawings, The frame 1 herein and the Face mask 25 that is carried thereby have application to being worn by healthcare providers or by those who will be in the presence of others in an environment in which one may encounter a contagious disease. By way of example only, the frame 1 will typically be worn by those who wish to avoid spreading or becoming infected with a coronavirus, namely, that known as COVID-19. However, the particular reason for one to wear the frame 1 should not be considered as a limitation of the scope of this invention. In this same regard, the particular face mask to be carried by the frame 1 is a matter of choice depending upon the circumstances of and reasons for its use and, likewise, should not be considered as a limitation of this invention.

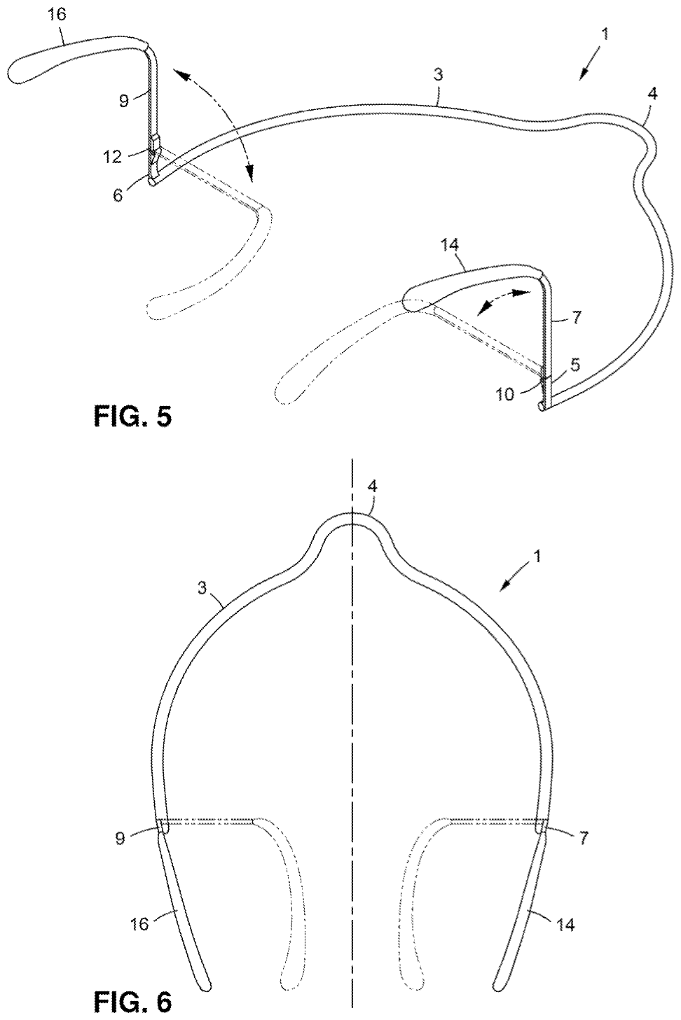

The frame 1 includes a horizontally extending bridge 3 that is preferably a thin rod that is manufactured from a lightweight flexible material such as molded plastic, metal or the like. The bridge 3 is curved to match the contour of the face of a wearer. An outward projection 4 (best shown FIGS. 5 and 6) is formed in the front and center of the bridge 3 to accommodate the nose of the wearer therewithin. Pivotally connected to opposite ends of the horizontally extending bridge 3 by way of respective coupling legs 5 and 6 are L-shaped ear engaging arms 7 and 9. The ear engaging arms 7 and 9 are rotatable at first ends thereof relative to the bridge 3 by means of hinges 10 and 12 that are connected, such as by means of pivot pins (not shown), injection molding, welding or any outer suitable technique, between the arms 7 and 9 and adjacent ones of the coupling legs S and 6.

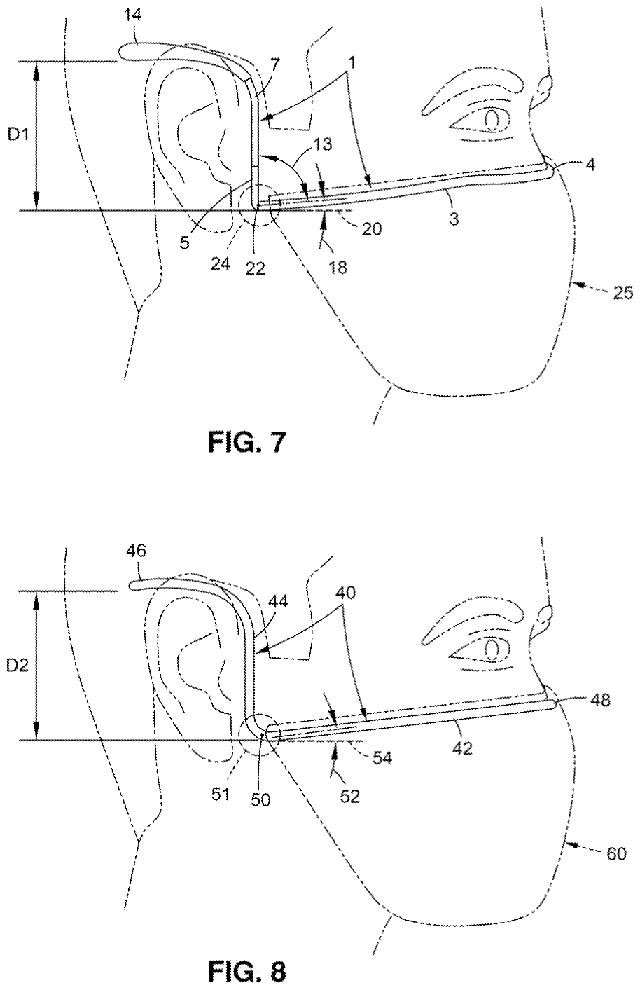

With the frame 1 in a ready to wear configuration as best shown in FIGS. 5 and 6, the ear engaging arms 7 and 9 stand vertically upwardly from the opposite ends of the bridge 3 so that an angle (designated 13 in FIG. 7) of approximately 90 degrees is created therebetween. At those times when the frame 1 will not be used, it can be easily deployed in a compact folded configuration. To deploy frame 1 in its compact folded configuration, each of the ear engaging arms 7 and 9 is rotated at its hinge 10 or 1 downwardly through an angle of approximately 90 degrees from its upstanding vertical position to a horizontal position lying flat and in the same plane in which the bridge 3 lies. When the ear engaging arms 7 and 9 have been rotated downwardly as just explained, the space consumed by the frame is reduced relative to the space that will be consumed by the frame in its aforementioned ready to wear configuration. In this case, the frame 1 is sized to be conveniently carried in a handbag or a purse of the wearer.

The tops of the L-shaped ear engaging arms 7 and 9 that lie opposite the hinged ends thereof bend rearwards and then straight back to create ear rests 14 and 16. As is best shown in FIG. 3, when the frame 1 is in its aforementioned ready to wear configuration and placed against the face of a wearer, each of the ear rests (e.g., 14) lays entirely above and on top of an ear of the wearer. It may be appreciated that the ear rests 14 and 16 do not surround or wrap around the wearer's ears. By virtue of the foregoing, the ear rests 14 and 16 are unlikely to catch onto the hair, earrings or other ear jewelry of the wearer. In this same regard, because the ear rests 14 and 16 apply no pressure to the back of the wearer's ears, the frame 1 will be comfortable to wear. Moreover, the frame 1 can be quickly and easily placed on and removed from the face of the wearer by simple slide on pushing .and slide off pulling steps.

Referring particularly to FIG. 7, details of the frame 1 are now described by which the face mask 25 that is attached to the bridge 3 and carried by the frame 1 can be held snug against the face of the wearer. To achieve this result, the bridge 3 of the frame 1 slopes continuously downward from the nose projection 4 at the front and center of the bridge 3 to each of the opposite ends of the bridge to which respective ores of the coupling legs (e.g., 5) are connected. That is, the downwardly sloping bridge 3 of the frame 1 makes a small angle (designated 18 in FIG. 7) of between 5 to 15 degrees with respect to a horizontal reference line 20. It is also important that each of the coupling legs 5, to which an ear engaging arm (e.g., 7) is hingedly connected, be connected to one end of the bridge 3 at an engagement point 22 that is located adjacent the wearer's ear lobe and above the wearer's temporal mandibular joint at one side of the user's head. However, it has been found that the advantages of the frame 1 can be achieved if the engagement point 22 that is located on the frame 1 at one side of the wearer's face lies within a circle 24 having a center that coincides with the wearer's temporal mandibular joint and a radius of ½ inch. FIG. 7 also shows that the distance (designated D) between an ear rest 14 that extends rearwardly from the top of the L-shaped ear engaging arm 7 of the frame 1 and the engagement point 22 at which the coupling leg 5 and one end of bridge 3 are connected together at one side of the wearer's face is substantially equal to the length of the wearer's ear. In this same regard, the aforementioned horizontal reference line 20 that makes the angle 18 with the downsloping bridge 3 runs through the engagement point 22.

Because the frame 1 of this invention holds the mask 25 snug against the wearer's face, the mask is less likely to slide down and require that it be frequently pulled up and repositioned on the wearer's face. Moreover, with the mask 25 held close to, the wearer's face, the wearer's breathing is less likely to cause his or her eyeglasses to fog.

Turning briefly to FIG. 4 of the drawings, the medical face mask 25 is shown attached to the bridge 3 by which to be carried by the frame 1. The face mask 25 is preferably manufactured from cloth but, as earlier indicated, the particular use of the face mask and the material from which it is manufactured are not be considered limitations of this invention. The face mask 25 is folded over and back upon itself and tied together below the top thereof by means of stitching 26 to establish a looped hem 27 through which the bridge 3 of the frame is received, such that the mask will be suspended from and hang downwardly from the bridge. A piece of cushion material (e.g., foam) 29 may be located inside the hem 27 to surround some or all of the bridge 3 to relieve the pressure of the mask being held snug against the wearer's face. The top of the mask 25 is also folded over and back upon itself to be tied together by the stitching 26 to create an elongated ring 30 that extends laterally across the mask 25 to lie behind the hem 27. An elastic (e.g., rubber) rod or band 32 having a spring memory runs through the ring 30 to prevent the mask from moving away from the face of the wearer.

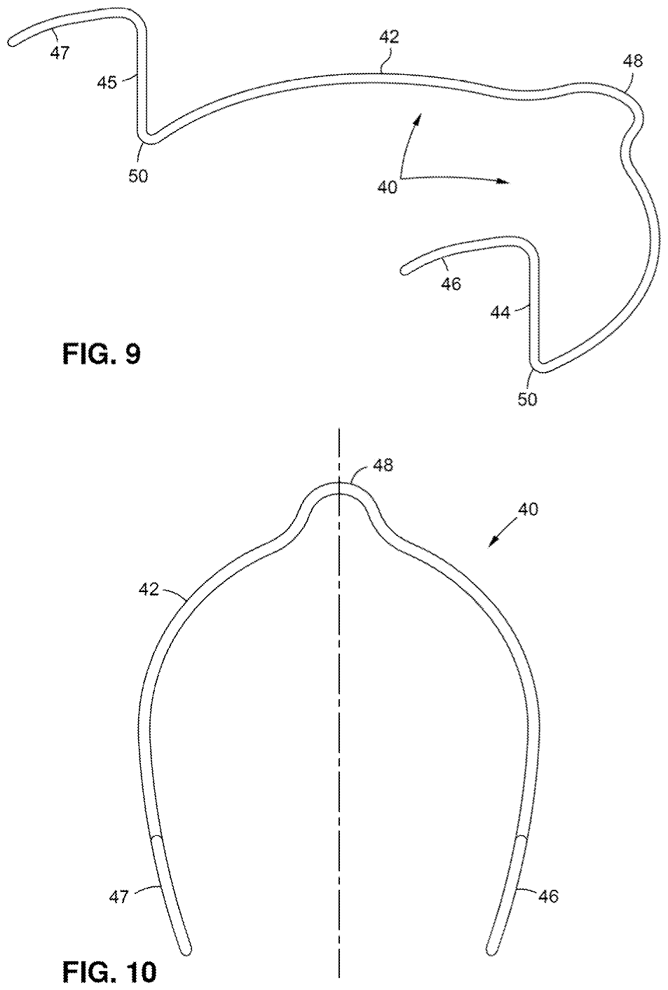

FIGS. 8-10 of the drawings show an alternate embodiment for a frame 40 to carry a medical face mask 60. Unlike the frame 1 that is shown in FIGS. 3 and 5-7, the entire frame 40 that is shown in FIGS. 8-10 is manufactured from a single continuous piece (e.g., a thin rod) of lightweight flexible (e.g., molded plastic or metal) material. In this case, the mask 50 that is carried by the frame 40 can be removed in a manner to be herein described so as to be replaced or cleaned and reused.

As in the case of the earlier described frame 1, the frame 40 includes a curved, horizontally extending bridge 42 which runs through a hem (such as that designated 27 in FIG. 4) formed near the top of the mask 60. The frame also includes L-shaped ear engaging urns 44 and 45 that stand vertically upward from opposite ends of the horizontally extending bridge 42 to lie at opposite sides of the wearer's face. An ear rest 46 and 47 bends rearwardly and straight back from the top of each ear engaging arm 44 and 45 to lay entirely above and rest on top of the wearer's ear, However, in this case, the hinges (designated 10 and 12 in FIG. 5) are eliminated, and each upstanding ear engaging arm 44 and 45 is coextensively joined to one end of the bridge 42. In this same regard, the ear engaging arms 44 and 45 are not rotatable relative to the bridge, such that the frame 1 remains at all times in a ready to wear configuration.

As in the case of the details provided for the frame 1 shown in FIG. 7, the bridge 42 of the frame 40 shown in FIG. 8 slopes continuously downward from a nose projection 48 at the front and center of the bridge 42 to engagement points 50 at opposite ends of the bridge to which respective ones of the upstanding ear engaging arms 44 are coextensively joined. Like that shown in FIG. 7, the downwardly sloping bridge 42 makes a small (about 5-15 degrees) angle 52 with respect to a horizontal reference line 54 that runs through the engagement point 50 at one side of the frame 40. It is important to the frame 40 shown in FIG. 8 that each engagement point 50 that lies at the intersection of an upstanding L-shaped ear engaging arm 44 and one end of the horizontally extending bridge 42 be located adjacent the wearer's ear lobe and above the wearer's temporal mandibular joint at one side of the user's head. As in the case of the frame 1, the advantages of the frame 40 can be achieved if the engagement point 50 that is located on the frame 40 at one side of the wearer's face lies within a circle 50 having a center that coincides with the wearer's temporal mandibular joint and a radius of ½ inch. FIG. 8 also shows that the distance D2 between an ear rest 46 and an engagement point 50 at each side of the wearer's face is substantially equal to the length of the wearer's ear.

Because of the continuous one-piece construction of the frame 40 of FIGS. 8-10, the face mask 60 is slideable horizontally over and along the bridge 42, upwardly along one of the ear engaging arms 44, and outwardly and off the ear rest 46 that bends rearwardly from the ear engaging arm 44, such that the mask 60 is removed from the frame. As earlier described, the mask 60 can be cleaned and reused or replaced by a new face mask. In either event, the mask 60 is returned to the frame 40 by sliding it back into engagement with bridge 42 to depend downwardly therefrom.

1. A frame to be worn on the face of a wearer to hold a face mask carried by the frame against the wearer's face, said frame comprising:
a curved bridge to which the face mask is attached, said curved bridge having first and opposite ends and being configured to lie on the face of the wearer between the wearer's ears; and
a pair of ear engaging arms standing upwardly from respective first and opposite ends of said bridge, said ear engaging arms being sized to engage the wearer's ears and thereby hold the frame on the wearer's face,
wherein each of said pair of upstanding ear engaging arms communicates with a respective one of the first and opposite ends of said curved bridge at an engagement point that is located on said frame and configured so as to lie adjacent the wearer's ear lobe at one side of the wearer's face and above the wearer's temporal mandibular joint at a corresponding one side of the wearer's head.

2. The frame recited in claim 1, wherein said curved bridge has a center located between said first and opposite ends thereof, said curved bridge sloping continuously downward from said center towards each of said engagement points with which respective ones of said pair of upstanding ear engaging arms communicate.

3. The frame recited in claim 2, wherein said curved downward sloping bridge makes an angle of between 5 to 15 degrees with respect to a horizontal reference line that runs through one of said engagement points with which one of said pair of upstanding ear engagement arms communicates.

4. The frame recited in claim 2, wherein there is formed at the center of said curved bridge an outwardly extending projection that is sized to receive the nose of the wearer therewithin.

5. The frame recited in claim 1, wherein each of said pair of upstanding ear engagement arms communicates with a respective one of the first and opposite ends of said curved bridge by way of a hinge, such that each of said upstanding ear engagement arms is rotatable at said hinge between a vertical position extending above the bridge to a horizontal position lying flat and in the same plane as the bridge.

6. The frame recited in claim 1, wherein each of said pair of upstanding ear engaging arms has a first end at which to communicate with a respective one of the first and opposite ends of said curved bridge, an opposite end, and an ear rest extending outwardly from said opposite end and positioned so as to lie on top of an ear of the wearer.

7. The frame recited in claim 6, wherein each of said pair of upstanding ear engaging arms and the ear rest extending outwardly from the opposite end thereof has an “L” shape so that said frame slides into engagement with and off the wearer's face in response to pushing and pulling forces applied thereto.

8. The frame recited in claim 1, wherein said curved bridge and said pair of ear engaging arms that communicate with and stand upwardly from the respective first and opposite ends of said bridge are formed from a single continuously extending piece of material, such that said bridge and said pair of ear engaging arms are coextensively joined one to another.

9. A combination comprising:
a face mask; and
a frame to which said face mask is attached, said frame holding said face mask against the face of a wearer, said frame including:
a bridge to which the face mask is attached, said bridge having first and opposite ends and being configured to lie on the face of the wearer between the wearer's ears; and
a pair of ear engaging arms standing upwardly from respective first and opposite ends of said bridge, said ear engaging arms being sized to engage the wearer's ears and thereby hold the frame on the wearer's face,
wherein each of said pair of upstanding ear engaging arms communicates with a respective one of the first and opposite ends of said bridge at an engagement point that is located on said frame and configured so as to lie adjacent the wearer's ear lobe at one side of the wearer's face and above the wearer's temporal mandibular joint at a corresponding one side of the wearer's head,
and wherein a first portion of said face mask is folded over and back upon itself to establish a hem within which to slidably receive said bridge therethrough by which said face mask is attached to said frame, said face mask being slideable off said bridge by which said face mask is removed from said frame.

10. The combination recited in claim 9, wherein the bridge of said frame and the pair of ear engaging arms of said frame that communicate with and stand upwardly from the respective first and opposite ends of said bridge are formed from a single continuously extending piece of material, such that said bridge and said pair of ear engaging arms are coextensively joined one to another.

11. The combination recited in claim 9, wherein a second portion of said face mask is folded over and back upon itself to establish an elongated ring within which an elastic band is received having a spring memory by which to prevent said face mask from sliding off the face of the wearer.

12. The combination recited in claim 9, wherein said bridge has a center located between said first and opposite ends thereof, said bridge sloping continuously downward from said center towards each of said engagement points with which respective ones of said pair of upstanding ear engaging arms communicate.
